(19) United States
(12) Patent Application Publication
(10) Pub. No.: US 2012/0088126 A1
(43) Pub. Date: Apr. 12, 2012

(54) BATTERY ASSEMBLY

(75) Inventor: Laurence Sang-Kyu Ahn, Yongin-si (KR)

(73) Assignee: Samsung SDI Co., Ltd., Yongin-si (KR)

(21) Appl. No.: 13/083,468

(22) Filed: Apr. 8, 2011

(30) Foreign Application Priority Data
Oct. 12, 2010 (KR) 10-2010-0099293

(51) Int. Cl. H01M 2/02; H01M 10/42; H01M 2/10

(52) U.S. Cl. 429/7; 429/163; 429/151

(57) ABSTRACT

A battery assembly comprises: an electrode assembly including a positive electrode plate, a negative electrode plate, and a separator disposed between the positive electrode plate and the negative electrode plate; a case for accommodating the electrode assembly; and an alignment member for aligning the case, wherein a depressed portion is formed on at least one side of the case, corresponding to the alignment member.

### RELATED APPLICATIONS

This application claims the benefit of Korean Patent Application No. 10-2010-0099293, filed on Oct. 12, 2010, in the Korean Intellectual Property Office, the disclosure of which is incorporated herein in its entirety by reference.

### BACKGROUND

1. Field

One or more embodiments of the present invention relate to a battery assembly, and more particularly, to a structure of a battery assembly.

2. Description of the Related Technology

The supply of portable computers that are operable by use of a battery without the need of a power supply device is quickly increasing according to development of wireless Internet and communication technologies. Generally, portable computers have excellent mobility since portable computers are small and easy to carry around, and thus are widely used for business or personal use. Portable computers may include a built-in battery pack so as to be freely used in various places without having to use a power supply device. Also, a built-in battery pack may include a secondary battery that is repeatedly used via charging and discharging.

Here, a plurality of batteries may be connected in series or in parallel for high output. The plurality of batteries may be aligned for easy electrical coupling.

### SUMMARY

One or more embodiments of the present invention include a structure of a battery assembly capable of easily aligning and fixing a plurality of batteries.

Additional aspects will be set forth in part in the description which follows and, in part, will be apparent from the description, or may be learned by practice of the presented embodiments.

According to one or more embodiments of the present invention, a battery assembly includes: an electrode assembly including a positive electrode plate, a negative electrode plate, and a separator disposed between the positive electrode plate and the negative electrode plate; a case accommodating the electrode assembly; and an alignment member for aligning the case, wherein a depressed portion is formed on at least one side of the case, corresponding to the align member.

The alignment member may axially rotate.

The alignment member extending in a first direction may be disposed corresponding to the depressed portion of each of a plurality of the cases stacked along the first direction.

The depressed portion may be formed along at least a part of a curved surface having a first radius, and the alignment member may be formed along at least a part of a curved surface having a second radius.

The first radius may be larger than the second radius.

The first radius may be not larger than the second radius.

At least a part of an edge portion of the depressed portion may have a curved surface.

At least a part of the alignment member corresponding to the edge portion of the depressed portion may have a curved portion.

A center of the depressed portion and a center of the alignment member may be disposed to be coupled within an interval not larger than twice the second radius of the alignment member along a second direction.

A center of the depressed portion and a center of the alignment member may be disposed to be coupled within a predetermined interval along a third direction.

The battery assembly may further include a frame accommodating the case, wherein the alignment member may be disposed on the frame.

A coupling groove may be formed on the case, corresponding to an internal structure of the frame.

The battery assembly may further include a handle extending from the alignment member so as to rotate the alignment member.

The alignment member may include a slide preventing member.

The slide preventing member may include an elastic material.

The battery assembly may further include a packing material for accommodating the electrode assembly and a polymer type electrolyte, wherein the packing material may be accommodated in the case.

The electrode assembly may further include a first electrode and a second electrode extending from the electrode assembly, and the case may include: a first terminal guide unit, wherein the first electrode extends from the case to face a first direction; and a second terminal guide unit, wherein the second electrode extends from the case to face a direction opposite to the first direction.

At least one of the depressed portions may be formed on a side of the case.

At least one of the depressed portions may be formed on each side of the case, and at least one of the alignment members may be included corresponding to the at least one depression portion.

According to one or more embodiments of the present invention, a battery assembly includes: a plurality of electrode assemblies, each electrode assembly including a positive electrode plate, a negative electrode plate, and a separator disposed between the positive electrode plate and the negative electrode plate; a plurality of cases, each case including an electrode assembly; an alignment member for axially rotating a plurality of the cases to align the plurality of cases; and a frame for accommodating the case and on which the align member is disposed, wherein a depressed portion is formed on at least one side of each of the cases, corresponding to the align member.

According to one or more embodiments of the present invention, a battery assembly includes: an electrode assembly including a positive electrode plate, a negative electrode plate, and a separator disposed between the positive electrode plate and the negative electrode plate; a protection circuit module electrically connected to the electrode assembly; a case comprising a first portion for accommodating the electrode assembly, and a second portion for accommodating the protection circuit module; and an alignment member for axially rotating a plurality of the cases to align the plurality of cases, wherein a depressed portion is formed on one side of at least one of the first and second cases, corresponding to the alignment member.

### BRIEF DESCRIPTION OF THE DRAWINGS

These and other aspects will become apparent and more readily appreciated from the following description of the embodiments, taken in conjunction with the accompanying drawings of which:

FIG. 1 is a perspective view schematically illustrating a battery assembly according to an embodiment of the present invention;

FIG. 2 is cross-sectional views taken along a line II-II of FIG. 1, for schematically describing an operating principle of an align member;

FIGS. 3A and 3B, 4A and 4B, 5A and 5B, and 6A and 6B are modified examples of cross-sectional views taken along the line II-II of FIG. 1, respectively schematically illustrating cases before and after a case and an align member are coupled to each other;

FIG. 7 is a perspective view schematically illustrating a battery assembly including a plurality of unit cells;

FIG. 8 is a perspective view schematically illustrating a modified example of the battery assembly of FIG. 7;

FIG. 9 is a perspective view schematically illustrating another modified example of the battery assembly of FIG. 7;

FIG. 10 is a perspective view schematically illustrating another modified example of the battery assembly of FIG. 7;

FIG. 11 is a perspective view schematically illustrating a battery assembly according to another embodiment of the present invention; and

FIGS. 12A and 12B are cross-sectional views taken along the line II-II of FIG. 1, respectively schematically illustrating cases before and after a align member and a case are coupled to each other, wherein a slide preventing member is further included.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Terms used herein are for descriptive purposes only and are not intended to limit the scope of the invention. The terms “comprises” and/or “comprising” are used to specify the presence of stated elements, steps, operations, and/or components, but do not preclude the presence or addition of one or more other elements, steps, operations, and/or components. The terms “first”, “second, and the like may be used to describe various elements, but do not limit the elements. Such terms are only used to classify one element from another.

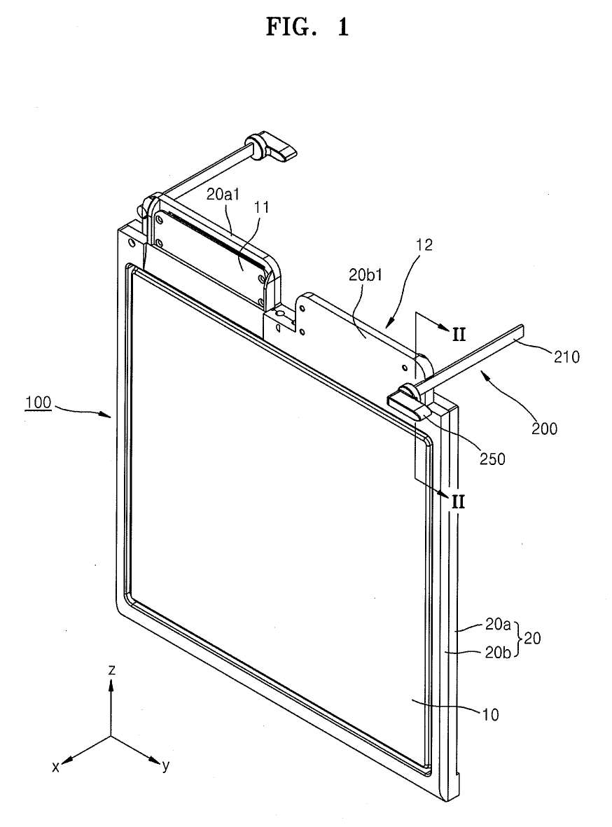

FIG. 1 is a perspective view schematically illustrating a battery assembly 100 according to an embodiment of the present invention. The battery assembly 100 may include a unit cell 10, a case 20, and an align unit 200.

Here, the unit cell 10 may include a pair of electrode terminals formed of a first electrode 11 and a second electrode 12. The first and second electrodes 11 and 12 may extend along an up-and-down direction Z of the unit cell 10 from an electrode assembly (not shown), and have a predetermined width. Here, the unit cell 10 may be a chargeable and dischargeable secondary battery, such as a nickel-cadmium battery, a nickel-hydrogen battery, a lithium-ion battery, or a lithium polymer battery.

Here, although not illustrated, the unit cell 10 may accommodate the electrode assembly. The electrode assembly may include a positive electrode plate, a negative electrode plate, and a separator disposed between the positive electrode plate and the negative electrode plate. The unit cell 10 may include a packing material for accommodating the electrode assembly. Here, for example, an electrolyte accommodated in the packing material may be a polymer type.

The case 20 may accommodate the unit cell 10. The first and second electrodes 11 and 12 may be taken out from the case 20 in such a way that exposed surfaces of the first and second electrodes 11 and 12 face opposite directions. Accordingly, the case 20 may include a first case 20a and a second case 20b that are mutually coupled, wherein the unit cell 10 is disposed therebetween. For example, the first case 20a may include a first terminal guide unit 20a1 extending in the up-and-down direction Z, corresponding to the first electrode 11, and the second case 20b may include a second terminal guide unit 20b1 extending in the up-and-down direction Z, corresponding to the second electrode 12. Here, the first electrode 11 may be disposed to face one side of the case 20 by facing the first terminal guide unit 20a1, and the second electrode 12 may be disposed to face another side of the case 20 by facing the second terminal guide unit 20b1. In other words, for example, referring to FIG. 1, the first electrode 11 may be disposed in such a way that the terminal guide unit 20a1 faces a first direction X, and the second electrode 12 may be disposed in such a way that the second terminal guide unit 20b1 faces a second direction X opposite to the first electrode 11. An embodiment of a shape of the case 20 and taking out directions of the first and second electrodes 11 and 12 are illustrated in FIG. 1, but the structure of the battery assembly 100 is not limited to that shown in FIG. 1, and the battery assembly 100 may include the unit cell 10 and the case 20 having any of various structures. In FIG. 1, the case 20 includes the unit cell 10 and the unit cell 10 accommodates the electrode assembly, but alternatively, the case 20 may include the electrode assembly. Also, when the unit cell 10 includes the packing material and the electrode assembly is accommodated in the packing material, the case 20 may accommodate the packing material. The case 20 may include an insulating member. For example, the insulating member may be coated on a surface of the case 20. Alternatively, the case 20 may be formed of a polymer material.

The align unit 200 may include an align member 210 and a handle 250. The align unit 200 may align and fix the case 20 accommodating the unit cell 10.

At least one align member 210 and at least one depressed portion C corresponding to the align member 210 may be formed on a side of the case 20. For example, at least one depressed portion C may be formed on each side of the case 20, and a plurality of align members 210 may be included corresponding to the plurality of depressed portions C. For example, as shown in FIG. 1, the align member 210 may be disposed on two sides of the case 20. However, the number and location of the align member 210 are not limited thereto. In other words, for example, one or more align members 210 may be disposed on top of or below the case 20.

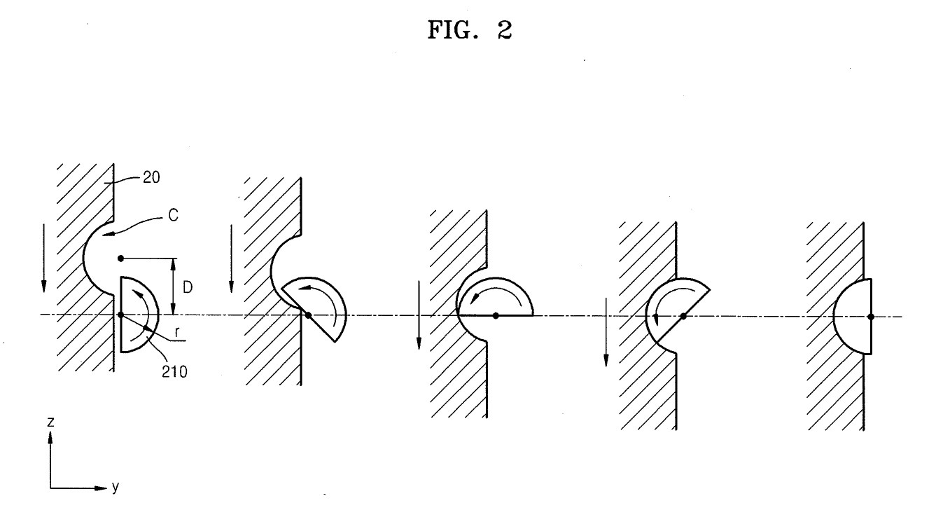

Here, the align member 210 may be configured to axially rotate around a point. The handle 250 may extend from the align member 210. A user may rotate the handle 250 to rotate the align member 210. Here, the depressed portion C may be formed on at least one side of the case 20, corresponding to the align member 210. One principle of aligning the case 20 by using the align member 210 will be described with reference to FIG. 2. FIG. 2 shows cross-sectional views taken along a line II-II of FIG. 1, for schematically describing an operating principle of the align member 210.

As the align member 210 rotates, the align member 210 is accommodated in the depressed portion C, thereby aligning the case 20. A process of moving and accommodating the case 20 by rotating the align member 210 is shown in FIG. 2, in five steps. Here, the center of the depressed portion C and the center of the align member 210 may be spaced apart from each other by a predetermined distance D in the up-and-down direction Z. Here, the predetermined distance D may not be larger than twice the radius r of the align member 210. In other words, the align member 210 may be disposed in such a way that an interval between the center of the depressed portion C and the center of the align member 210 is within a range not larger than twice the radius r of the align member 210.

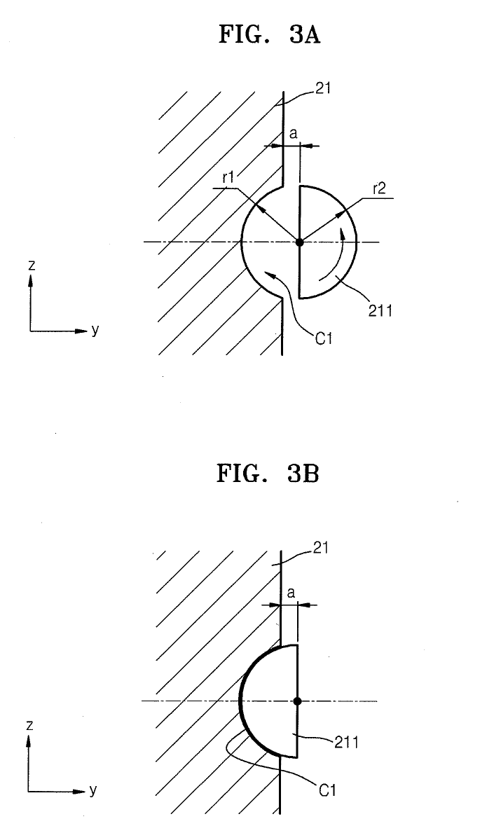

Here, cross-sectional shapes of the depressed portion C and the align member 210 are not limited to those shown in the embodiment of FIG. 2, and may be variously configured. Various embodiments of the align member 210 and the depressed portion C will now be described with reference to FIGS. 3A through 6B. However, the embodiments shown in FIGS. 3A through 6B are only modified examples, and the cross-sectional shapes of the align member 210 and the depressed portion C are not limited thereto. FIGS. 3A and 3B, 4A and 4B, 5A and 5B, and 6A and 6B are modified examples of cross-sectional views taken along the line II-II of FIG. 1, respectively illustrating cases before and after the case 20 and the align member 210 are coupled to each other.

Referring to FIGS. 3A and 3B, a depressed portion C1 is formed along at least a part of a curved surface having a first radius r1, and an align member 211 may include at least a part of a curved surface having a second radius r2. Here, the center of the align member 211 may be separated from a case 21 by a predetermined horizontal direction separation distance along a horizontal direction Y. Here, the align member 211 may be accommodated in the depressed portion C1, and may align and support the case 21 along the up-and-down direction Z within a predetermined range. Also, the align member 211 may prevent the case 21 from moving in the horizontal direction Y by supporting the case 21. Accordingly, the align member 211 may align and support the case 21 at a predetermined location. In FIGS. 3A and 3B, the first and second radiuses r1 and r2 have the same length, but the first radius r1 may be larger than, equal to, or smaller than the second radius r2.

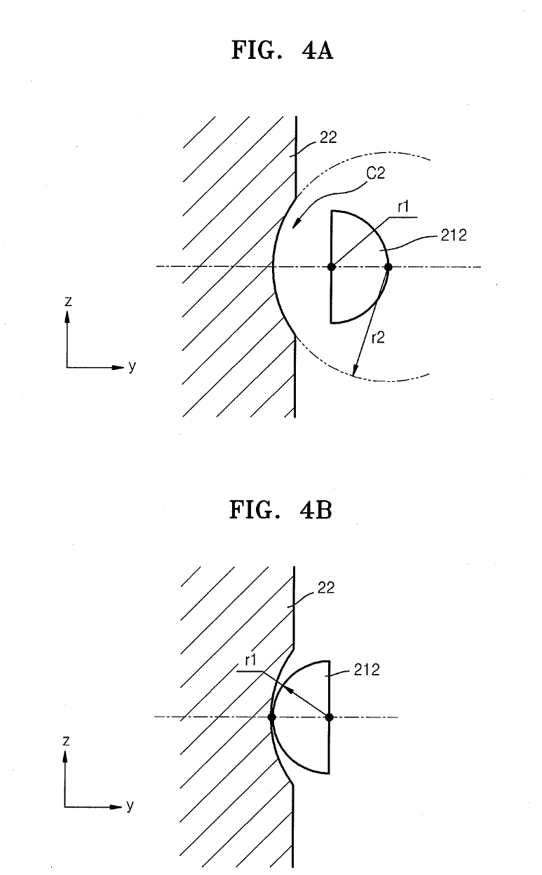

Referring to FIGS. 4A and 4B, a depressed portion C2 may be formed along a part of a curved surface having a second radius r2. Here, the second radius r2 may be larger than the first radius r1 of an align member 212. Here, the depressed portion C2 of a case 22 and the align member 212 may be configured to contact at a point with respect to a cross section. Here, the align member 212 may support and fix a location of the case 22 in the horizontal direction Y. Also, the align member 212 may support movement of the case 22 in the up-and-down direction Z and the horizontal direction Y via the point-contact. Here, although not illustrated, according to an embodiment of the present invention, the first radius r1 of the depressed portion C2 may be smaller than the second radius r2 of the align member 212. Here, a part of the align member 212 may be blocked by the depressed portion C2 to align the case 20.

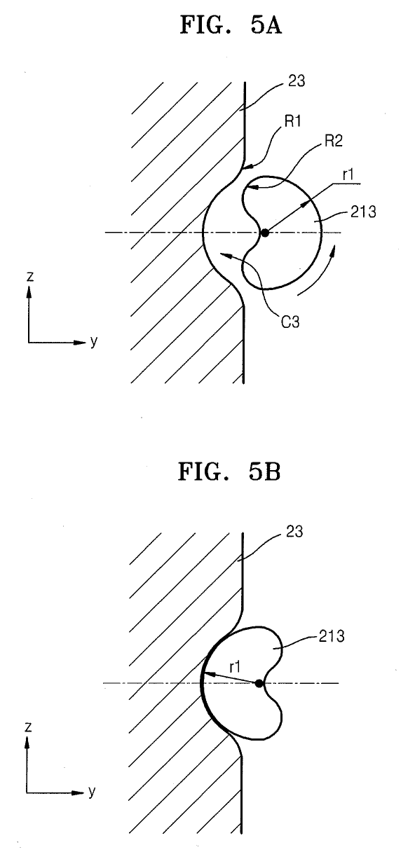

Referring to FIGS. 5A and 5B, at least a part of an edge portion of a depressed portion C3 may have a curved surface R1. Also, an align member 213 may have a curved surface R2 corresponding to the edge portion of the depressed portion C3. The curved surface R1 of the depressed portion C3 and the curved surface R2 of the align member 213 may easily lead relative motion between a case 23 and the align member 213. In other words, the curved surfaces R1 and R2 may prevent the case 23 and the align member 213 from bumping into each other and enable the case 23 and the align member 213 to slide against each other.

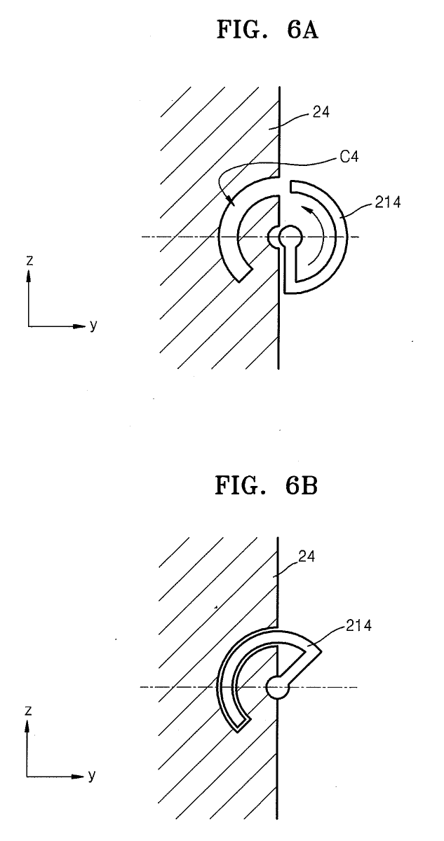

Referring to FIGS. 6A and 6B, a depressed portion C4 may be configured to correspond to an align member 214. In other words, the depressed portion C4 may be configured to correspond to the align member 214 having a hook shape. Here, a case 24 may be supported and fixed at a predetermined location by rotating the align member 214. As described with reference to FIGS. 3A through 6B, the align members 211 through 214 and the depressed portions C1 through C4 respectively corresponding to the align members 211 through 214 may have various cross-sectional shapes, but the cross-sectional shape of the align member 214 is not limited thereto.

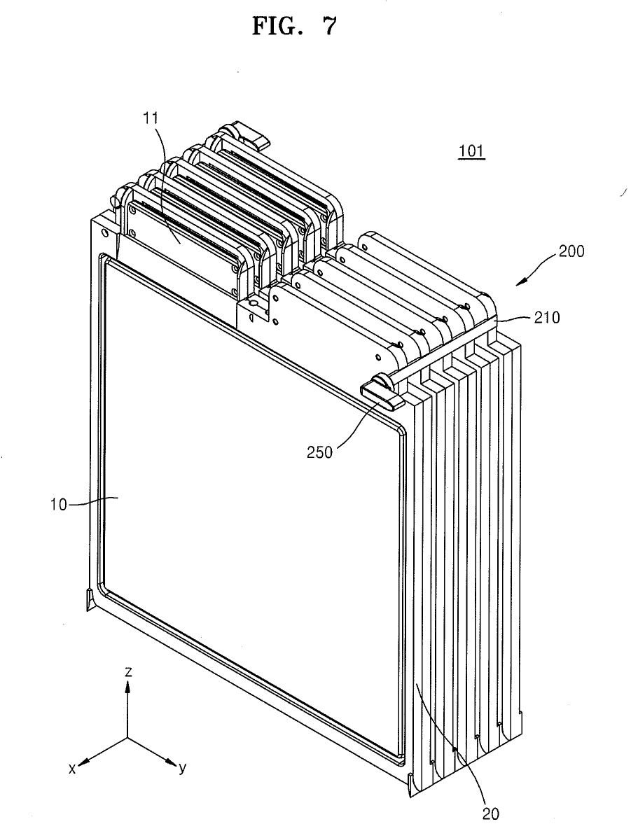

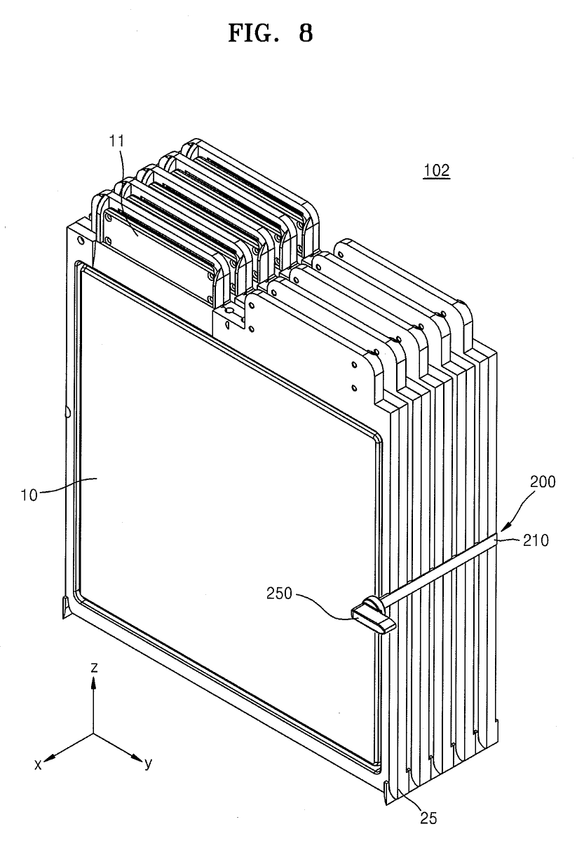

As shown in FIG. 1, the align unit 200 may align and fix a location of a single case 20, but a number of the case 20 is not limited to one. FIG. 7 is a perspective view schematically illustrating a battery assembly 101 including a plurality of unit cells 10. Referring to FIG. 7, the battery assembly 101 may include a plurality of cases 20 that are stacked along the first direction X. The align member 210 may extend along the first direction X, corresponding to the depressed portion C of each case 20. As such, the locations of the plurality of cases 20 may be easily aligned and supported without having to individually rearrange the locations of the cases 20 or the unit cells 10, by manipulating the align member 210. Here, the handle 250 extending from the align member 210 may be rotated so as to manipulate the align member 210. As described above, the location of the align unit 200 is not limited thereto. For example, referring to FIG. 8, a battery assembly 102 may include a plurality of cases 25. Here, the align member 210 may be disposed on a side of the cases 25, and the depressed portion C may also be disposed on the side of the cases 25 corresponding to the align member 210.

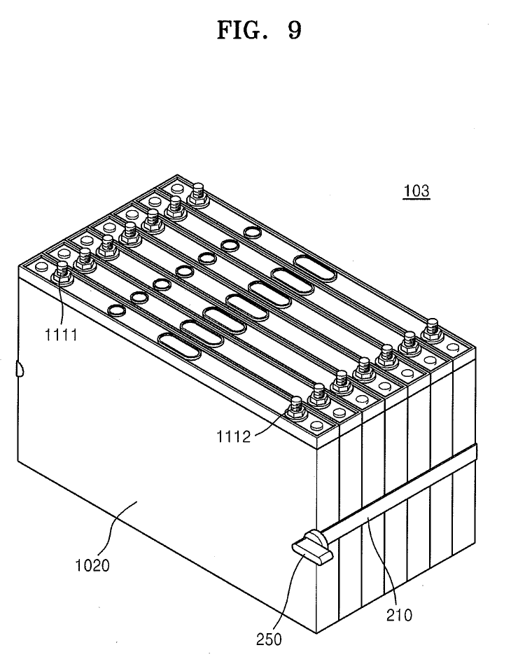

The cases 20 and 25 of FIGS. 1, 7, and 8 may accommodate one or more unit cells 10 therein. However, alternatively, a battery assembly 103 may include a plurality of unit cells as shown in FIG. 9. Here, each unit cell may include a case 1020 accommodating an electrode assembly (not shown) therein, and a first electrode 1111 and a second electrode 1112 that extend from the electrode assembly. Here, the first and second electrodes 1111 and 1112 may protrude from one side of the case 1020. Here, a depressed portion and the align member 210 corresponding to the depressed portion may be disposed on at least a part of the side of the case 1020 accommodating the electrode assembly.

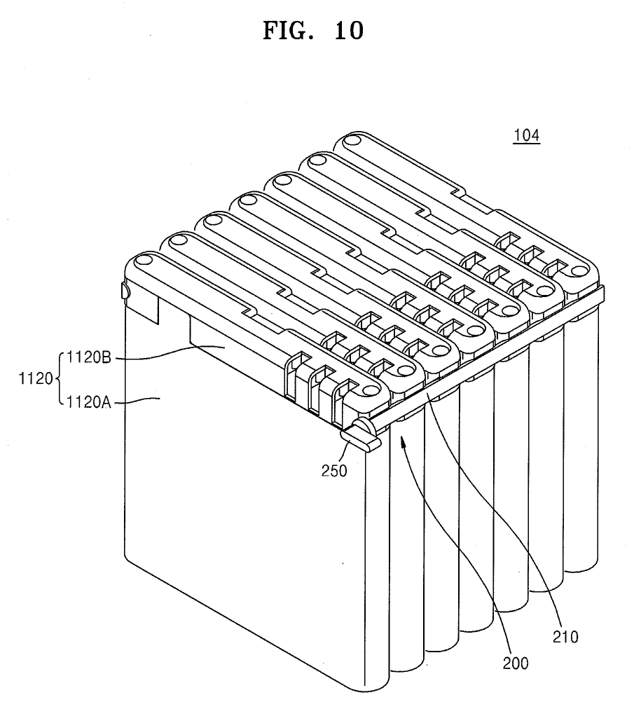

Referring to FIG. 10, a battery assembly 104 may include a plurality of battery packs. Here, the battery pack may include a first case 1120A and a second case 1120B. The first case 1120A may accommodate an electrode assembly (not shown). The second case 1120B may accommodate a protection circuit module (not shown) that is electrically connected to the electrode assembly. Here, the depressed portion C may be formed on at least one of the first and second cases 1120A and 1120B. Here, the align member 210 may be disposed corresponding to the depressed portion C. In FIG. 10, the align member 210 is formed on a side of the second case 1120B, but the location of the align member 210 is not limited thereto. In other words, the align member 210 may be formed on a side of the first case 1120A or on sides of the first and second cases 1120A and 1120B. Alternatively, a plurality of align members 210 and a plurality of depressed portions C corresponding to the align members 210 may be formed.

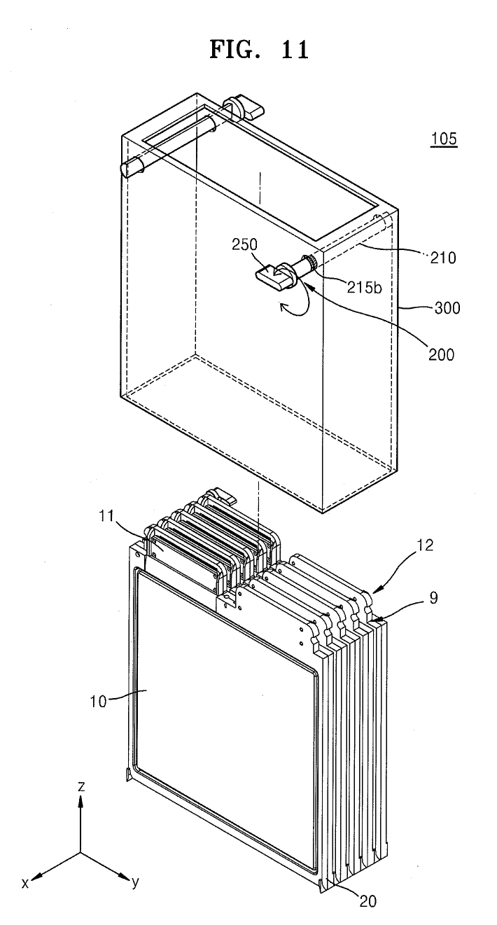

Referring to FIG. 11, a battery assembly 105 may further include a frame 300. Here, the align member 210 may be disposed on the frame 300. Here, the frame 300 may be configured to accommodate at least one case 20 therein. In other words, a plurality of cases 20 may be disposed in the frame 300, and then the align member 210 may align the locations of the cases 20. Here, the cases 20 and the frame 300 may be configured in such a way that the frame 300 and the cases 20 are easily coupled to each other. For example, in FIG. 11, a coupling groove 9 may be formed on right and left sides of the first and second electrodes 11 and 12 of the cases 20. In other words, the coupling groove 9 may be formed on the cases 20, corresponding to an internal shape of the frame 300, so that the frame 300 and the cases 20 are easily coupled to each other. The shape of the coupling groove 9 shown in FIG. 11 is only an example, and may vary according to a coupling portion shape of the frame 300 or a structure of the cases 20.

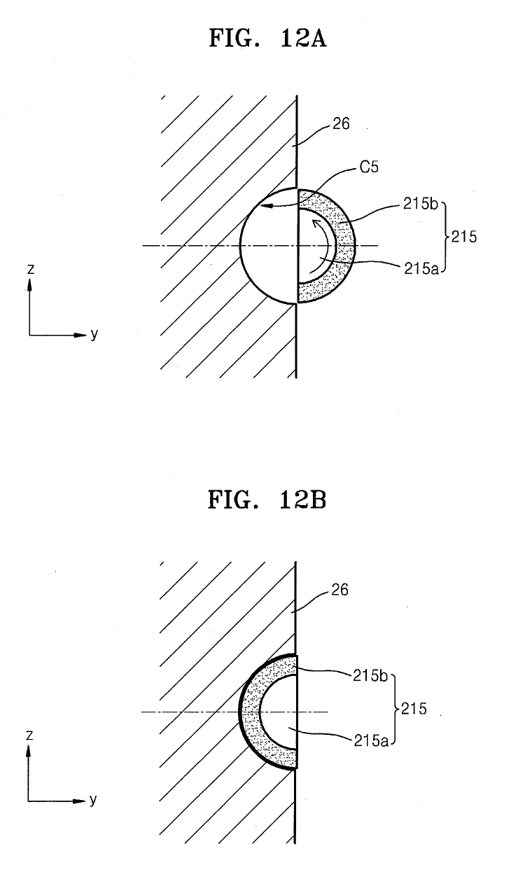

Here, the align unit 200 may further include a slide preventing member 215b so that the coupling between the align member 210 and the depressed portion C does not get loose. FIGS. 12A and 12B are cross-sectional views taken along the line II-II of FIG. 1, respectively schematically illustrating cases before and after an align member 215a and a case 26 are coupled to each other, wherein the slide preventing member 215b is further included. Here, the slide preventing member 215b may include an elastic material. Accordingly, the align member 210 does not come loose from a depressed portion C5 after coupling due to elasticity. The slide preventing member 215b may be formed on a surface of the align member 210, but the location of the slide preventing member 215b is not limited thereto. For example, the slide preventing member 215b may be formed inside the depressed portion C5. Alternatively, referring to FIG. 11, the slide preventing member 215b may be disposed between the frame 300 and the align member 210.

As described above, according to the one or more of the above embodiments of the present invention, a plurality of batteries can be easily aligned and fixed in a battery assembly.

It should be understood that the embodiments described therein should be considered in a descriptive sense only and not for purposes of limitation. Descriptions of features or aspects within each embodiment should typically be considered as available for other similar features or aspects in other embodiments.

What is claimed is:

1. A battery assembly comprising:
an electrode assembly comprising a positive electrode plate, a negative electrode plate, and a separator disposed between the positive electrode plate and the negative electrode plate;
a case accommodating the electrode assembly; and
an alignment member for aligning the case,
wherein a depressed portion is formed on at least one side of the case, corresponding to the alignment member.

2. The battery assembly of claim 1, wherein the alignment member axially rotates.

3. The battery assembly of claim 1, wherein the alignment member extending in a first direction is disposed corresponding to the depressed portion of each of a plurality of the cases stacked along the first direction.

4. The battery assembly of claim 1, wherein the depressed portion is formed along at least a part of a curved surface having a first radius, and the alignment member is formed along at least a part of a curved surface having a second radius.

5. The battery assembly of claim 4, wherein the first radius is larger than the second radius.

6. The battery assembly of claim 4, wherein the first radius is not larger than the second radius.

7. The battery assembly of claim 4, wherein at least a part of an edge portion of the depressed portion has a curved surface.

8. The battery assembly of claim 7, wherein at least a part of the alignment member corresponding to the edge portion of the depressed portion has a curved portion.

9. The battery assembly of claim 4, wherein a center of the depressed portion and a center of the alignment member are disposed to be coupled within an interval not larger than twice the second radius of the alignment member along a second direction.

10. The battery assembly of claim 1, wherein a center of the depressed portion and a center of the alignment member are disposed to be coupled within a predetermined interval along a third direction.

11. The battery assembly of claim 1, further comprising a frame accommodating the case, wherein the alignment member is disposed on the frame.

12. The battery assembly of claim 11, wherein a coupling groove is formed on the case, corresponding to an internal structure of the frame.

13. The battery assembly of claim 1, further comprising a handle extending from the alignment member so as to rotate the align member.

14. The battery assembly of claim 1, wherein the alignment member comprises a slide preventing member.

15. The battery assembly of claim 14, wherein the slide preventing member comprises an elastic material.

16. The battery assembly of claim 1, further comprising a packing material for accommodating the electrode assembly and a polymer type electrolyte, wherein the packing material is accommodated in the case.

17. The battery assembly of claim 1, wherein the electrode assembly further comprises a first electrode and a second electrode extending from the electrode assembly, and the case comprises:
a first terminal guide unit, wherein the first electrode extends from the case to face a first direction; and
a second terminal guide unit, wherein the second electrode extends from the case to face a direction opposite to the first direction.

18. The battery assembly of claim 1, wherein at least one of the depressed portions is formed on a side of the case.

19. The battery assembly of claim 1, wherein at least one of the depressed portions is formed on each side of the case, and at least one of the alignment members is included corresponding to the at least one depressed portion.

20. A battery assembly comprising:
a plurality of electrode assemblies, each electrode assembly comprising a positive electrode plate, a negative electrode plate, and a separator disposed between the positive electrode plate and the negative electrode plate;
a plurality of cases, each case comprising an electrode assembly;
an alignment member for axially rotating a plurality of the cases to align the plurality of cases; and
a frame for accommodating the cases and on which the alignment member is disposed,
wherein a depressed portion is formed on at least one side of each of the cases, corresponding to the alignment member.

21. A battery assembly comprising:
an electrode assembly comprising a positive electrode plate, a negative electrode plate, and a separator disposed between the positive electrode plate and the negative electrode plate;
a protection circuit module electrically connected to the electrode assembly;
a plurality of cases, each case comprising a first portion for accommodating the electrode assembly, and a second portion for accommodating the protection circuit module; and
an alignment member for axially rotating a plurality of the cases to align the plurality of cases,
wherein a depressed portion is formed on one side of at least one of the first and second portions, corresponding to the alignment member.

22. A battery assembly comprising:
an electrode assembly comprising a positive electrode plate, a negative electrode plate, and a separator disposed between the positive electrode plate and the negative electrode plate;
a case accommodating the electrode assembly, wherein the case comprises a major surface;
a groove formed on at least one side of the case; and
an alignment member contacting the groove and positioned along a direction transverse to the major surface of the case.
